(19) United States
(12) Patent Application Publication
(10) Pub. No.: US 2020/0272985 A1
(43) Pub. Date: Aug. 27, 2020

(54) DYNAMIC DISTRIBUTED SMART CONTRACTING

(71) Applicant: Inlecom Systems Limited, London (GB)

(72) Inventors: VASSILEIOS KARAKOSTAS, Macclesfield (GB); Yash Chadha, London (GB); Ioanna Fergadiotou, Athens (GR); Patrick J. O'Sullivan, Dublin (IE)

(21) Appl. No.: 16/285,804

(22) Filed: Feb. 26, 2019

(51) Int. Cl. G06Q 10/08; H04L 9/32

(52) U.S. Cl. CPC G06Q 10/0833; H04L 9/3242; G06Q 10/08355; G06Q 10/0832

(57) ABSTRACT

A smart contracting method includes receiving in an intermediate way station disposed on a route between an originator and destination of shipment of an item, digital terms of shipment for the transport of the item, and a digital contract of transport of the item from the originator to the destination, and matching the terms to pre-stored data indicating an ability of the way station to meet the terms. Thereafter, portions of the contract are identified corresponding to the way station and requirements of the identified portions are matched to pre-stored rules indicating a willingness of the way station to agree to particular terms. Finally, a digital signature for the way station is affixed to the contract and, on condition that the terms and requirements match, a next way station on the route is selected, and transmission of the contract and the terms are directed to the selected next way station.

### BACKGROUND OF THE INVENTION

### Field of the Invention

The present invention relates to the field of product transport in a supply chain and more particularly to contracting for product transport within a supply chain.

### Description of the Related Art

A supply chain is a network between a company and its suppliers to produce and distribute a specific product, and the supply chain represents the steps it takes to get the product or service to the customer. Supply chain management is a crucial process because an optimized supply chain results in lower costs and a faster production cycle. Business logistics management refers to the production and distribution process within the company, while supply chain management includes suppliers, manufacturers, logistics and transportation companies and retailers that distribute the product to the end customer. Supply chains include every business that comes in contact with a particular product, including companies that assemble and deliver parts to the manufacturer.

Because the traditional supply chain involves many different actors utilizing many different disparate information systems, information sharing amongst the different actors can be challenging. Transparency into the state of affairs of a given transaction depends largely upon the willingness and diligence of each actor in the supply chain of the transaction to provide accurate and timely information to one another. In a single transaction, so much seems not so daunting, but in a supply chain ecosystem of hundreds if not thousands of transactions are ongoing at any given time and much of the resources available within the ecosystem—particularly in respect to transportation and logistics—remain dependent upon the state of multiple different transactions.

A supply chain information sharing system aims to provide some transparency into the state of affairs of different transactions in a corresponding supply chain. As part of the transparency, the supply chain information system ingests data from different actors in the supply chain, processes the ingested data in order to produce a result reflective of a state of the supply chain, and exposes the produced result to one or more of the actors. In a supply chain spanning a single jurisdiction amongst only a handful of actors, so much is not of tremendous consequence, but in a supply chain that spans different jurisdictional boundaries and involves many different actors with different policies regarding the privacy of data, maintaining both transparency of transactions in the supply chain while not running afoul of the data privacy policies of both the private actors in the supply chain and the public governmental interests in which the actors reside can be challenging.

### BRIEF SUMMARY OF THE INVENTION

Embodiments of the present invention address deficiencies of the art in respect to contracting for product transit in a supply chain and provide a novel and non-obvious method, system and computer program product for dynamic distributed smart contracting in the transport of product within a supply chain. In an embodiment of the invention, a smart contracting method includes receiving in an intermediate way station disposed on a route between an originator of shipment of an item and a destination indicated for the item, digital terms of shipment for the transport of the item, and a digital contract of transport of the item from the originator to the destination. The method also includes matching the terms of the shipment to pre-stored data indicating an ability of the way station to meet the terms of the shipment. Optionally, the digital terms may be verified by decrypting the digital contract with a public key of the originator and comparing the decrypted digital contract with a hash of the digital terms.

Thereafter, portions of the contract are identified that correspond to the way station and requirements of the identified portions are then matched to pre-stored rules indicating a willingness of the intermediate way station to agree to particular contract terms. Finally, a digital signature for the intermediate way station is affixed to the digital contract. In one aspect of the embodiment, the digital signature is a hash of the digital contract encrypted with a private key of the intermediate way station. On condition that the terms and requirements match, a next way station on the route selected, and transmission of the digital contract and terms of shipment directed to the selected next way station. To the extent that the pre-stored rules do not indicate a willingness of the intermediate way station to agree to particular terms, though, a message is transmitted to the originator rejecting the digital contract.

In yet another aspect of the embodiment, the next way station is selected by retrieving from a cache, different capabilities of a multiplicity of different way stations, comparing the different capabilities with the terms of the shipment, and selecting one of the multiplicity of the different way stations that has capabilities which match a greatest number of the terms of the shipment. In even yet another aspect of the embodiment, the next way station is selected by querying each of a multiplicity of different way stations for a list of corresponding capabilities, comparing each list received from the multiplicity of different way stations, and selecting one of the multiplicity of the different way stations that has capabilities which match a greatest number of the terms of the shipment. In even yet another aspect of the embodiment, the next way station is selected by retrieving from a cache, different capabilities of a multiplicity of different way stations, comparing the different capabilities with the terms of the shipment, filtering the multiplicity of different way stations to a subset, querying each way station in the subset for a list of updated capabilities, and selecting one of the way stations in the subset that has capabilities which match a greatest number of the terms of the shipment.

In another embodiment of the invention, a data processing system is configured for dynamic distributed smart contracting. The system includes a host computing platform of one or more computers, each with memory and at least one processor. The host computing platform includes a communicative coupling over computer communications network to different remote computing systems. Each of the different remote computing systems corresponds to a different way station on a route between an originator of a shipment of an item and a destination indicated for the item. Of note, the host computing platform corresponds to an intermediate way station disposed on the route.

The system also includes a smart contracting module. The module includes computer program instructions executing in the memory of the host computing platform and enabled to perform receiving in the intermediate way station digital terms of shipment for the transport of the item, and a digital contract of transport of the item from the originator to the destination and matching the terms of the shipment to pre-stored data indicating an ability of the way station to meet the terms of the shipment. The instructions also are enabled to perform identifying portions of the contract corresponding to the way station and matching requirements of the identified portions to pre-stored rules indicating a willingness of the intermediate way station to agree to particular contract term. Finally, the instructions are enabled to perform affixing a digital signature for the intermediate way station to the digital contract on condition that the terms and requirements match and then selecting a next way station on the route and, directing transmission of the digital contract and terms of shipment to the selected next way station, but otherwise transmitting a message to the originator rejecting the digital contract.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for dynamic distributed smart contracting;

FIG. 2 is a schematic illustration of a data processing system configured for dynamic distributed smart contracting; and,

FIG. 3 is a flow chart illustrating a process for dynamic distributed smart contracting.

### DETAILED DESCRIPTION OF THE INVENTION

Embodiments of the invention provide for dynamic distributed smart contracting. In accordance with an embodiment of the invention, a smart contract includes one or more digital terms of shipment for the transport of an item, and one or more digital signatures indicating acquiescence to the digital terms by each party to the transport of the item. The smart contract is propagated from a source way station disposed on a route between an originator of shipment of the item and a destination indicated for the item, to each intermediate way station on the route. At each way station, the terms of the shipment are matched to pre-stored data indicating an ability of the way station to meet the terms of the shipment. To that end, each way station identifies portions of the contract corresponding to the way station and matches requirements of the identified portions to pre-stored rules indicating a willingness of the way station to agree to particular contract terms. If agreeable, then a digital signature for the way station is affixed to the digital contract and a next way station on the route selected. Finally, the digital contract and terms of shipment are transmitted to the selected next way station.

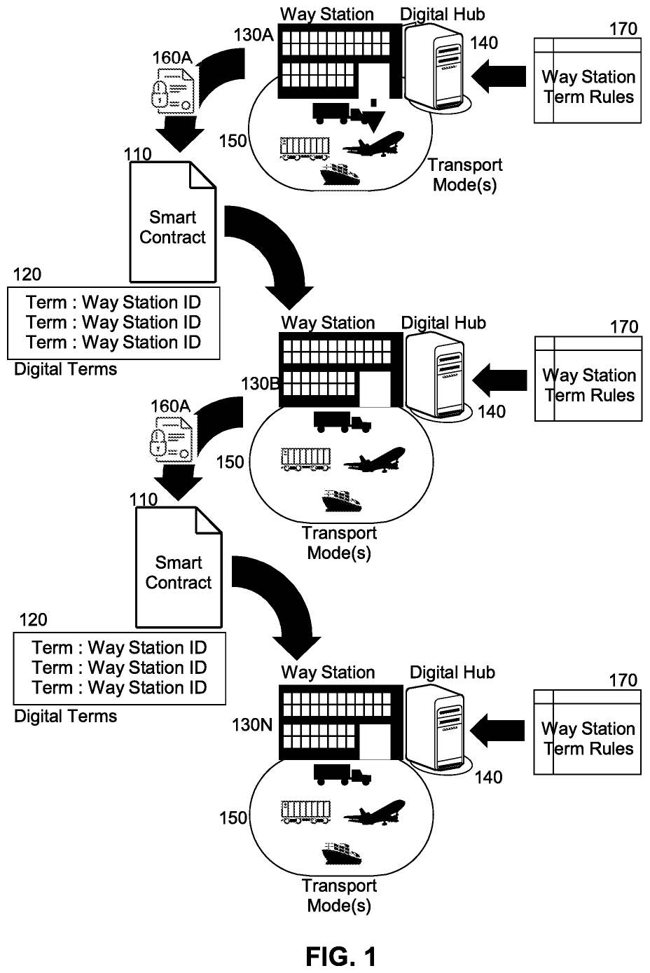

In further illustration, FIG. 1 pictorially shows a process for dynamic distributed smart contracting. As shown in FIG. 1, different way stations 130A, 130B, 130N are provided in sequence so as to define a transportation route of a shipping container from an origin way station 130A to a destination way station 130N with one or more intermediate way stations 130B disposed therebetween. Each of the way stations 130A, 130B, 130N include a digital hub 140, and are associated with one or more prospective modes of transport 150, such as rail, truck, ship and airplane such that containers received in a corresponding one of the different way stations 130A, 130B, 130N may be received in one of the modes of transport 150 and forwarded to a next one of the different way stations 130A, 130B, 130N by a same or different one of the modes of transport 150. Each of the way stations 130A, 130B, 130N includes a set of rules 170 defining parameters within which a corresponding one of the way stations 130A, 130B, 130N is able to agree to transport an item. Those parameters may range from minimum pricing to transport an item, to minimum transport times in transporting an item, to geographic range parameters within which an item may be transported, to a specified mode of transport 150, and so forth.

In operation, a smart contract 110 is received in a first one of the way stations 130A. The smart contract 110 includes a set of digital terms 120, with portions of the digital terms 120 being assigned to different ones of the way stations 130A, 130B, 130N. The digital terms 120 specify conditions on the transport of an item, such as a minimum time permitted to transport the item, a price of transport, a required mode of transport, and the like. The digital hub 140 of the way station 130A receives the smart contract 110 and parses the digital terms 120 in order to identify a portion of the digital terms 120 directed to the way station 130A. The digital hub 140 then applies the terms of the identified portion to the way station term rules 170 in order to determine if all of the terms of the identified portion are able to be supported by the way station 130A. If so, the digital hub 140 signs the smart contract 110 by encrypting the identified portion of the digital terms 120 with a private key 160A of the way station 130A making the agreed upon terms of the identified portion, immutable.

Thereafter, the way station 130A selects a next way station 130B to receive the smart contract 110. In this regard, the next way station 130B is selected, for instance, by querying each of a selection of prospective next way stations 130B to determine which is able to acquiesce to the most number of the digital terms 120. Alternatively, a cache of known capabilities of a selection of prospective next way stations 130B may be queried to determine which is able to acquiesce to the most number of the digital terms 120. As yet another alternative, a cache of known capabilities of a selection of prospective next way stations 130B may be queried to determine which is able to acquiesce to the most number of the digital terms 120 in order to produce a subset of the way stations 130B and the way stations 130B in the subset may then be queried to determine which is able to acquiesce to the most number of the digital terms 120. In any event, once a next way station 130B is selected, the smart contract 110 is transmitted to the next way station 130B in the transport route and the process continues. When the smart contract 110 has been processed and signed by the destination way station 130N, the smart contract 110 is then returned to the originator with the knowledge that every term of the digital terms 120 has been agreed to by each one of the way stations 130A, 130B, 130N in the transportation route.

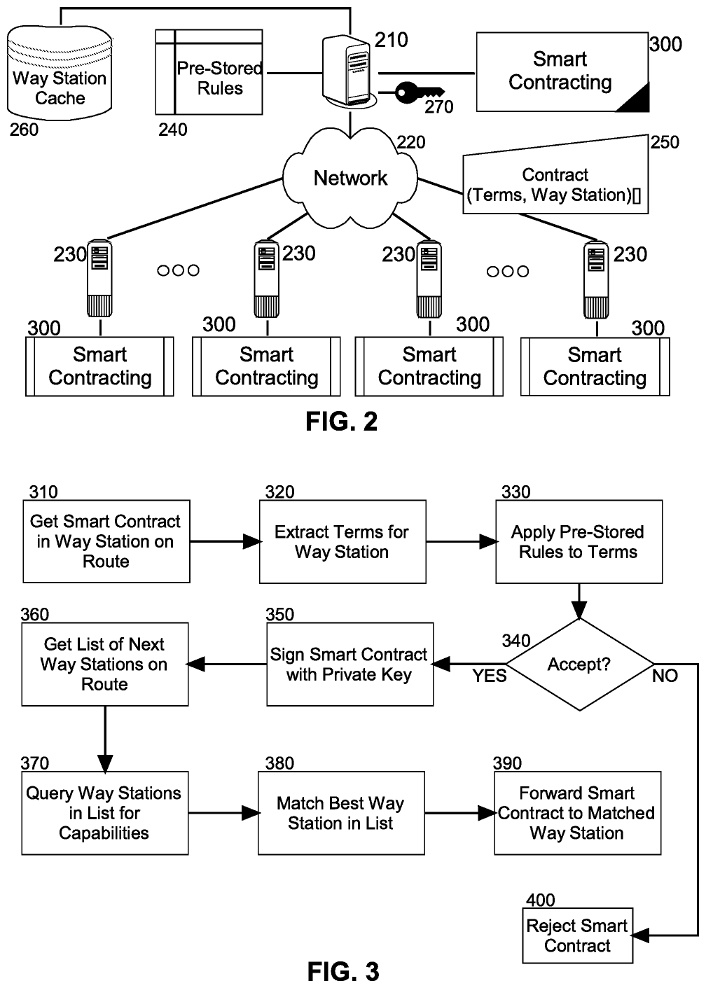

The process described in connection with FIG. 1 can be implemented in a data processing system. In further illustration, FIG. 2 schematically shows a data processing system configured for dynamic distributed smart contracting. The system includes a host computing platform that includes one or more computers, each with memory and at least one processor and corresponding to a specific way station in a route for transportation of an item, for an origin way station to a destination way station. The host computing platform 210 supports the operation of a smart contracting module 300. As well, the host computing platform 210 is communicatively coupled to different remote server computers 230, each supporting a corresponding smart contracting module 300 and each corresponding to another way station in the route.

Each smart contracting module 300 includes computer program instructions operable upon execution in memory of a corresponding computer, to receive a smart contract 250 and to extract digital terms from the smart contract 250. The program instructions additionally are operable to apply pre-stored rules 240 to the extracted digital terms in order to identify any terms not acceptable to a corresponding one of the way stations. The program instructions are further operable to sign the smart contract 250 with a private key 270 of the corresponding one of the way stations to the extent that all of the digital terms are deemed acceptable by the pre-stored rules. Finally, the program instructions are operable to select a next one of the way stations on the route and to forward the signed smart contract to the selected next one of the way stations. In this regard, the program instructions are enabled to retrieve from cache 260, known capabilities of a selection of prospective next way stations to determine which is able to acquiesce to the most number of the terms of the smart contract 250 so as to select the way station to receive the smart contract 250 most likely to be able to acquiesce to the terms of the smart contract 250.

In even yet further illustration of the operation of the smart contracting module 300, FIG. 3 is a flow chart illustrating a process for dynamic distributed smart contracting. Beginning in block 310, a smart contract is received in a digital hub of a recipient way station in the route from origin way station to destination way station. In block 320, the digital terms of the smart contract are extracted and the smart contract is verified by decrypting the smart contract with the public key of the originator of the smart contract and comparing the decrypted smart contract with a hash of the digital terms accompanying the smart contract. In block 330, pre-stored rules for the recipient way station are retrieved and applied to those of the digital terms of the smart contract pertaining to the recipient way station in order to identify any terms unacceptable to the recipient way station. In decision block 340, if all terms are acceptable based upon the application of the rules, the process continues through block 350. Otherwise, the smart contract is rejected in block 400.

In block 350, to the extent that the pre-stored rules when applied to the digital terms fails to identify any unacceptable terms, the smart contract is signed by the recipient way station by encrypting the digital terms of the smart contract pertaining to the recipient way station with a private key of the recipient way station. Thereafter, in block 360 a list of next potential way stations in the route is determined and in block 370, each of the way stations in the list is queried for respective capabilities in transporting the item to the destination way station. In block 380, one of the way stations best matching the digital terms of the smart contract is selected and in block 390, the smart contract is forwarded to the selected way station.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for dynamic distributed smart contracting comprising:
receiving in an intermediate way station disposed on a route between an originator of shipment of an item and a destination indicated for the item, digital terms of shipment for the transport of the item, and a digital contract of transport of the item from the originator to the destination;
matching the terms of the shipment to pre-stored data indicating an ability of the way station to meet the terms of the shipment;
identifying portions of the contract corresponding to the way station and matching requirements of the identified portions to pre-stored rules indicating a willingness of the intermediate way station to agree to particular contract terms;
affixing a digital signature for the intermediate way station to the digital contract on condition that the terms and requirements match and then selecting a next way station on the route; and,
directing transmission of the digital contract and terms of shipment to the selected next way station, but otherwise transmitting a message to the originator rejecting the digital contract.

2. The method of claim 1, wherein the digital signature is a hash of the digital contract encrypted with a private key of the intermediate way station.

3. The method of claim 1, wherein the digital terms are verified by decrypting the digital contract with a public key of the originator and comparing the decrypted digital contract with a hash of the digital terms.

4. The method of claim 1, wherein the next way station is selected by retrieving from a cache, different capabilities of a multiplicity of different way stations, comparing the different capabilities with the terms of the shipment, and selecting one of the multiplicity of the different way stations that has capabilities which match a greatest number of the terms of the shipment.

5. The method of claim 1, wherein the next way station is selected by querying each of a multiplicity of different way stations for a list of corresponding capabilities, comparing each list received from the multiplicity of different way stations, and selecting one of the multiplicity of the different way stations that has capabilities which match a greatest number of the terms of the shipment.

6. The method of claim 1, wherein the next way station is selected by retrieving from a cache, different capabilities of a multiplicity of different way stations, comparing the different capabilities with the terms of the shipment, filtering the multiplicity of different way stations to a subset, querying each way station in the subset for a list of updated capabilities, and selecting one of the way stations in the subset that has capabilities which match a greatest number of the terms of the shipment.

7. A data processing system configured for dynamic distributed smart contracting, the system comprising:
a host computing platform of one or more computers, each with memory and at least one processor, the host computing platform comprising a communicative coupling over computer communications network to different remote computing systems, each of the different remote computing systems corresponding to a different way station on a route between an originator of a shipment of an item and a destination indicated for the item, the host computing platform corresponding to an intermediate way station disposed on the route; and,
a smart contracting module comprising computer program instructions executing in the memory of the host computing platform and enabled to perform:
receiving in the intermediate way station digital terms of shipment for the transport of the item, and a digital contract of transport of the item from the originator to the destination;
matching the terms of the shipment to pre-stored data indicating an ability of the way station to meet the terms of the shipment;
identifying portions of the contract corresponding to the way station and matching requirements of the identified portions to pre-stored rules indicating a willingness of the intermediate way station to agree to particular contract terms;
affixing a digital signature for the intermediate way station to the digital contract on condition that the terms and requirements match and then selecting a next way station on the route; and,
directing transmission of the digital contract and terms of shipment to the selected next way station, but otherwise transmitting a message to the originator rejecting the digital contract.

8. The system of claim 7, wherein the digital signature is a hash of the digital contract encrypted with a private key of the intermediate way station.

9. The system of claim 7, wherein the digital terms are verified by decrypting the digital contract with a public key of the originator and comparing the decrypted digital contract with a hash of the digital terms.

10. The system of claim 7, wherein the next way station is selected by retrieving from a cache, different capabilities of a multiplicity of different way stations, comparing the different capabilities with the terms of the shipment, and selecting one of the multiplicity of the different way stations that has capabilities which match a greatest number of the terms of the shipment.

11. The system of claim 7, wherein the next way station is selected by querying each of a multiplicity of different way stations for a list of corresponding capabilities, comparing each list received from the multiplicity of different way stations, and selecting one of the multiplicity of the different way stations that has capabilities which match a greatest number of the terms of the shipment.

12. The system of claim 7, wherein the next way station is selected by retrieving from a cache, different capabilities of a multiplicity of different way stations, comparing the different capabilities with the terms of the shipment, filtering the multiplicity of different way stations to a subset, querying each way station in the subset for a list of updated capabilities, and selecting one of the way stations in the subset that has capabilities which match a greatest number of the terms of the shipment.

13. A computer program product for dynamic distributed smart contracting, the computer program product including a computer readable storage medium having program instructions embodied therewith, the program instructions executable by a device to cause the device to perform a method including:
receiving in an intermediate way station disposed on a route between an originator of shipment of an item and a destination indicated for the item, digital terms of shipment for the transport of the item, and a digital contract of transport of the item from the originator to the destination;
matching the terms of the shipment to pre-stored data indicating an ability of the way station to meet the terms of the shipment;
identifying portions of the contract corresponding to the way station and matching requirements of the identified portions to pre-stored rules indicating a willingness of the intermediate way station to agree to particular contract terms;
affixing a digital signature for the intermediate way station to the digital contract on condition that the terms and requirements match and then selecting a next way station on the route; and,
directing transmission of the digital contract and terms of shipment to the selected next way station, but otherwise transmitting a message to the originator rejecting the digital contract.

14. The computer program product of claim 13, wherein the digital signature is a hash of the digital contract encrypted with a private key of the intermediate way station.

15. The computer program product of claim 13, wherein the digital terms are verified by decrypting the digital contract with a public key of the originator and comparing the decrypted digital contract with a hash of the digital terms.

16. The computer program product of claim 13, wherein the next way station is selected by retrieving from a cache, different capabilities of a multiplicity of different way stations, comparing the different capabilities with the terms of the shipment, and selecting one of the multiplicity of the different way stations that has capabilities which match a greatest number of the terms of the shipment.

17. The computer program product of claim 13, wherein the next way station is selected by querying each of a multiplicity of different way stations for a list of corresponding capabilities, comparing each list received from the multiplicity of different way stations, and selecting one of the multiplicity of the different way stations that has capabilities which match a greatest number of the terms of the shipment.

18. The computer program product of claim 13, wherein the next way station is selected by retrieving from a cache, different capabilities of a multiplicity of different way stations, comparing the different capabilities with the terms of the shipment, filtering the multiplicity of different way stations to a subset, querying each way station in the subset for a list of updated capabilities, and selecting one of the way stations in the subset that has capabilities which match a greatest number of the terms of the shipment.
